(19) United States
(12) Patent Application Publication
(10) Pub. No.: US 2017/0182843 A1
(43) Pub. Date: Jun. 29, 2017

(54) Rubber Composition and Pneumatic Tire Using Same

(71) Applicant: The Yokohama Rubber Co., LTD., Minato-ku, Tokyo (JP)

(72) Inventors: Ryutaro Nakagawa, Hiratsuka-shi, Kanagawa (JP); Yoshiaki Kirino, Hiratsuka-shi, Kanagawa (JP); Yusuke Tanabe, Hiratsuka-shi, Kanagawa (JP)

(73) Assignee: The Yokohama Rubber Co., LTD., Minato-ku, Tokyo (JP)

(21) Appl. No.: 15/129,795

(22) PCT Filed: Mar. 27, 2015
(86) PCT No.: PCT/JP2015/059620

§ 371 Date: Sep. 27, 2016

(30) Foreign Application Priority Data
Mar. 27, 2014 (JP) 2014-066328

(51) Int. Cl. B60C 1/00; C08L 9/00; B60C 15/06

(52) U.S. Cl. CPC B60C 1/0025; B60C 15/0603; C08L 9/00; B60C 2001/005; B60C 2013/006

(57) ABSTRACT

A polyamide elastomer-containing rubber composition according to the present technology comprises, 100 parts by mass of (A) a diene rubber, from 30 to 80 parts by mass of (B) carbon black having a nitrogen adsorption specific surface area (N₂SA) of at least 35 m²/g and from 1 to 30 parts by mass of (C) a polyamide elastomer, the mass ratio of the (B) carbon black to the (C) polyamide elastomer being 1:0.35 to 1:1.

### TECHNICAL FIELD

The present technology relates to a rubber composition and a pneumatic tire using such a rubber composition; specifically, the present technology relates to a rubber composition of superior rigidity and reduced heat buildup, and to a pneumatic tire using the rubber composition.

### BACKGROUND ART

Increased environmental awareness in recent years has led to a demand for pneumatic tires exhibiting reduced heat buildup and improved fuel economy. Similar efforts have been made, for example, in tire sidewall compounds.

Using a rubber component having a high molecular weight is effective in reducing heat build-up, but increases the viscosity of the compound, thus reducing workability.

Viscosity can be reduced by increasing the amount of softeners such as process oils added to the compound, but doing so leads to problems such as increased heat build-up.

Meanwhile, tire bead fillers need to be highly rigid in order to suppress movement or separation of the bead cores and wrapped portions of the carcass layer. The practice of increasing adding increased amounts of reinforcing agents such as carbon black in order to increase bead filler rigidity is generally known; however, this practice leads to the problem of increased heat build-up.

There is thus a strong demand in the art for a rubber composition that yields both rigidity and reduced heat buildup.

International Patent Application Publication No. WO/2009/093695 discloses a rubber composition that contains from 0.1 to 50 parts by weight of a polyamide elastomer having a melting point of 100 to 180° C. and from 1 to 100 parts by weight of an inorganic reinforcing agent per 100 parts by weight of a vulcanizable rubber in order to improve elasticity, tensile strength, heat build-up, and fatigue properties.

However, such a polyamide elastomer constitutes foreign material within the rubber, and therefore can be a factor that increases heat build-up. In addition, the composition is incapable of improving rigidity to the level demanded in the art, and thus has room for improvement.

### SUMMARY

The present technology provides a rubber composition containing a polyamide elastomer, wherein the composition yields superior rigidity and reduced heat buildup, and a pneumatic tire using such a rubber composition.

As the result of diligent research, the inventors discovered that a composition having superior rigidity and reduced heat buildup can be achieved by compounding specific amounts of carbon black having a specific nitrogen adsorption specific surface area (N₂SA) and a polyamide elastomer into a diene rubber at a specific mass ratio of the carbon black to the polyamide elastomer.

Specifically, the present technology is as follows.

1. A rubber composition comprising, 100 parts by mass of (A) a diene rubber, from 30 to 80 parts by mass of (B) carbon black having a nitrogen adsorption specific surface area (N₂SA) of at least 35 m²/g and from 1 to 30 parts by mass of (C) a polyamide elastomer, a mass ratio of the (B) carbon black to the (C) polyamide elastomer being 1:0.35 to 1:1.

2. The rubber composition according to 1, wherein the mass ratio of the (B) carbon black to the (C) polyamide elastomer is 1:0.35 to 1:0.8.

3. The rubber composition according to 1, wherein the mass ratio of the (B) carbon black to the (C) polyamide elastomer is 1:0.4 to 1:0.6.

4. The rubber composition according to 1, wherein the (B) carbon black has a nitrogen adsorption specific surface area (N₂SA) of 35 to 120 m²/g.

5. The rubber composition according to 1, wherein the (C) polyamide elastomer has a soft segment Shore D hardness value at least 10 less than a hard segment Shore D hardness value thereof.

6. The rubber composition according to 5, wherein a difference between the soft segment Shore D hardness and the hard segment Shore D hardness of the (C) polyamide elastomer is 30 to 50.

7. A tire sidewall rubber composition comprising the rubber composition according to 1.

8. A tire bead filler rubber composition comprising the rubber composition according to 1.

9. A pneumatic tire in which the rubber composition described in claim 7 is used in a sidewall thereof.

10. A pneumatic tire in which the rubber composition described in 8 is used in a bead filler thereof.

In accordance with the present technology, specific amounts of carbon black having a specific nitrogen adsorption specific surface area (N₂SA) and a polyamide elastomer are added to a diene rubber at a specific mass ratio of the carbon black to the polyamide elastomer, thereby allowing the provision of a rubber composition of superior rigidity and reduced heat buildup and a pneumatic tire using such a rubber composition.

### DETAILED DESCRIPTION

The present technology will be now described in greater detail.

### Diene Rubber

Any diene rubber that can be contained in a rubber composition may be used as the diene rubber (A) used in the present technology. Examples of diene rubbers include natural rubber (NR), isoprene rubber (IR), butadiene rubber (BR), styrene-butadiene copolymer rubber (SBR), acrylonitrile-butadiene copolymer rubber (NBR), and the like. These may be used singly or in combinations of two or more types. There is no particular limitation upon the molecular weight and microstructure of the rubber component, which may be terminally modified with an amine, amide, silyl, alkoxysilyl, carboxyl, hydroxyl group, or the like, or may be epoxidized.

Of these various types of diene rubber, NR or BR is preferable in terms of yielding the effects of the present technology.

If the rubber composition of the present technology is used for a sidewall, it is preferable to contain from 20 to 50 parts by mass of NR or from 50 to 80 parts by mass of BR per 100 parts by mass of the diene rubber in order to prioritize cut resistance and cracking resistance. If the composition is used for a bead filler, it is preferable to contain from 50 to 80 parts by mass of NR or from 20 to 50 parts by mass of BR in order to prioritize increased rigidity.

### Carbon Black

The nitrogen adsorption specific surface area (N₂SA) of the carbon black constituting one component (B) used in the present technology is at least 35 m²/g. A nitrogen adsorption specific surface area (N₂SA) of less than 35 m²/g will lead to both reduced rigidity and increased heat build-up. In order to allow noticeably superior rigidity and reduced heat buildup, the nitrogen adsorption specific surface area (N₂SA) of the carbon black is preferably 35 to 120 m²/g; if the rubber composition of the present technology is used for a sidewall, a nitrogen adsorption specific surface area of 35 to 80 m²/g is more preferable, and 35 to 45 m²/g is particularly preferable in order to prioritize cracking resistance.

If the composition is used for a bead filler, a nitrogen adsorption specific surface area of 35 to 110 m²/g is more preferable, and 60 to 80 m²/g is particularly preferable in order to prioritize increased rigidity.

The nitrogen adsorption specific surface area (N₂SA) is a value calculated in accordance with JIS (Japanese Industrial Standard) K6217-2.

### Polyamide Elastomer

The polyamide elastomer constituting component (C) used in the present technology is a known elastomer, one of which is disclosed, along with a method for producing the elastomer, in International Patent Application Publication No. WO/2009/093695. The hard segments of the (C) polyamide elastomer are of polyamide, and the soft segments are of a multiblock copolymer composed of a polyether or a polyester. Examples of the material constituting the hard segments include nylon 6, 66, 610, 11, and 12, Examples of polyethers that can constitute the soft segments include polyethylene glycol, diol poly(oxytetramethylene) glycol, and poly(oxypropylene) glycol, and examples of polyesters include poly(ethylene adipate) glycol and poly(butylene-1,4-adipate) glycol. The soft segments can also be constituted by a block and/or multiblock copolymer of these materials.

A polyamide elastomer that is particularly preferable for yielding the effects of the present technology is a polyamide polyether elastomer comprising hard segments of nylon 12 and soft segments of polyether, the elastomer having a weight average molecular weight of 10,000 to 200,000. A commercially available version of such a polyether polyamide elastomer, such as UBESTA XPA P9040X1 produced by Ube Industries, Ltd., can be used.

It is preferable that the (C) polyamide elastomer have a soft segment Shore D hardness value at least 10 less than a hard segment Shore D hardness value thereof, as this will further improve the effects of the present technology. As used herein, soft segment and hard segment Shore D hardness refers to hardness when the respective segments are measured as units; in the case of the aforementioned polyether polyamide elastomer, for example, the Shore D hardness of the polyether preferably has a value at least 10 less than the Shore D hardness of the nylon 12. The difference in Shore D hardness is more preferably 30 to 50.

Shore D hardness is measured in accordance with JIS K 6253.

### Rubber Composition Compounding Ratios

The rubber composition of the present technology contains specific amounts of components (A) through (C). Specifically, the rubber composition of the present technology contains from 30 to 80 parts by mass of (B) the carbon black having a nitrogen adsorption specific surface area (N₂SA) of at least 35 m²/g, and from 1 to 30 parts by mass of (C) the polyamide elastomer per 100 parts by mass of the (A) diene rubber.

An amount of (B) carbon black less than 30 parts by mass is not preferable, as this will reduce reinforcement action and make it impossible to obtain the desired physical properties. Conversely, an amount exceeding 80 parts by mass will reduce dispersibility and degrade physical properties.

An amount of the (C) polyamide elastomer less than 1 part by mass will be too little to yield the effects of the present technology. Conversely, an amount exceeding 30 parts by mass will negatively affect rigidity and heat build-up, and will lead to roll retention and otherwise negatively affect workability.

The amount of (B) carbon black is preferably from 40 to 70 parts by mass per 100 parts by mass of the (A) diene rubber.

The amount of (C) polyamide elastomer is preferably from 15 to 30 parts by mass per 100 parts by mass of the (A) diene rubber.

In the rubber composition of the present technology, the mass ratio of the (B) carbon black to the (C) polyamide elastomer be 1:0.35 to 1:1. If the proportion of (C) polyamide elastomer is less than the minimum, heat build-up will worsen; if the proportion exceeds the maximum, both heat build-up and workability will worsen.

The mass ratio of the (B) carbon black to the (C) polyamide elastomer is more preferably 1:0.35 to 1:0.8, more preferably 1:0.4 to 1:0.6.

In addition to the aforementioned components, the rubber composition of the present technology can also contain various types of additives commonly added to rubber compositions, such as vulcanizing and cross-linking agents, vulcanizing and cross-linking accelerators, various types of oils, anti-aging agents, plasticizers, and the like. These additives may be mixed according to an ordinary method to form a composition, and used to perform vulcanization or cross-linking. Any conventional ordinary amount of these additives can be added to the extent that the object of the present technology is not hindered.

Examples of uses for the rubber composition of the present technology include conveyor belts, hoses, and tires; the composition is particularly preferably used in tires, and is particular advantageous for side treads and bead fillers by virtue of the superior rigidity and reduced heat buildup of the composition.

Additionally, the rubber composition produced according to the present technology can be used to manufacture a pneumatic tire according to a conventional method for manufacturing pneumatic tires.

### EXAMPLES

The present technology is further described in detail with reference to the working examples and comparative examples described hereinafter, but the present technology is not limited by these examples.

### Working Examples 1 To 8 and Comparative Examples 1 and 15

### Preparation of Samples

All of the components other than the vulcanization system (vulcanization accelerator, sulfur) were mixed for about three minutes and 30 seconds in a tangential mixer in the amounts (parts by mass) shown in tables 1 and 2, the vulcanization system was added to the obtained mixture, and the whole was mixed using an open roll to obtain a rubber composition. The rubber composition thus obtained was press-vulcanized in a predetermined mold at 160° C. for 15 minutes to fabricate a vulcanized rubber test strip. The physical properties of the obtained vulcanized rubber test strip were measured according to the following methods.

100% modulus (M100): A tensile test was performed at 23° C. in accordance with JIS K 6251 to measure tensile stress at 100% elongation. Results are expressed as index values against a value of 100 representing a comparative example having the same basic composition except for the (B) carbon black and the (C) polyamide elastomer. A larger index value indicates greater rigidity.

tanδ (60° C.): The tans of the vulcanized rubber test strip was measured with an Iwamoto Seisakusho viscoelasticity spectrometer under the following conditions: elongation deformation strain rate: 10±2%; frequency: 20 Hz; temperature: 60° C. Results are expressed as index values against a value of 100 representing a comparative example having the same basic composition except for the (B) carbon black and the (C) polyamide elastomer. A smaller index value indicates reduced heat buildup.

Results are shown in tables 1 and 2.

TABLE 1

| | Working | Working | Working |
|---|---|---|---|
| | Example 1 | Example 2 | Example 3 |
| NR*1 | 35 | 35 | 35 |
| BR*2 | 65 | 65 | 65 |
| Polyamide elastomer *3 | 20 | 30 | 15 |
| Carbon black 1 *4 | 50 | 50 | 30 |
| Carbon black 2 *5 | — | — | — |
| Carbon black 3 *6 | — | — | — |
| Zinc oxide *7 | 3 | 3 | 3 |
| Stearic acid *8 | 1.5 | 1.5 | 1.5 |
| Anti-aging agent *9 | 3.25 | 3.25 | 3.25 |
| Wax *10 | 1 | 1 | 1 |
| Oil *11 | 12 | 12 | 12 |
| Sulfur *12 | 1.54 | 1.54 | 1.54 |
| Sulfur-containing | 0.8 | 0.8 | 0.8 |
| vulcanization | | | |
| accelerator *13 | | | |
| (C)/(B) | 0.4 | 0.6 | 0.5 |
| | Against | Against | Against |
| | Comparative | Comparative | Comparative |
| Test results | Example 1 | Example 1 | Example 2 |
| M100 | 142 | 159 | 125 |
| tanδ (60° C.) | 89 | 86 | 88 |
| | Working | Working | Working |
| | Example 4 | Example 5 | Example 6 |
| NR*1 | 35 | 35 | 35 |
| BR*2 | 65 | 65 | 65 |
| Polyamide elastomer *3 | 30 | 20 | 30 |
| Carbon black 1 *4 | 30 | — | — |
| Carbon black 2 *5 | — | 50 | 50 |
| Carbon black 3 *6 | — | — | — |
| Zinc oxide *7 | 3 | 3 | 3 |
| Stearic acid *8 | 1.5 | 1.5 | 1.5 |
| Anti-aging agent *9 | 3.25 | 3.25 | 3.25 |
| Wax *10 | 1 | 1 | 1 |
| Oil *11 | 12 | 12 | 12 |
| Sulfur *12 | 1.54 | 1.54 | 1.54 |
| Sulfur-containing | 0.8 | 0.8 | 0.8 |
| vulcanization | | | |
| accelerator *13 | | | |
| (C)/(B) | 1 | 0.4 | 0.6 |
| | Against | Against | Against |
| | Comparative | Comparative | Comparative |
| Test results | Example 2 | Example 3 | Example 3 |
| M100 | 154 | 141 | 156 |
| tanδ (60° C.) | 82 | 95 | 95 |

| | Working | Working |
|---|---|---|
| | Example 7 | Example 8 |
| NR*1 | 35 | 35 |
| BR*2 | 65 | 65 |
| Polyamide elastomer *3 | 15 | 30 |
| Carbon black 1 *4 | — | — |
| Carbon black 2 *5 | 30 | 30 |
| Carbon black 3 *6 | — | — |
| Zinc oxide *7 | 3 | 3 |
| Stearic acid *8 | 1.5 | 1.5 |
| Anti-aging agent *9 | 3.25 | 3.25 |
| Wax *10 | 1 | 1 |
| Oil *11 | 12 | 12 |
| Sulfur *12 | 1.54 | 1.54 |
| Sulfur-containing | 0.8 | 0.8 |
| vulcanization | | |
| accelerator *13 | | |
| (C)/(B) | 0.5 | 1 |
| | Against | Against |
| | Comparative | Comparative |
| Test results | Example 4 | Example 4 |
| M100 | 128 | 152 |
| tanδ (60° C.) | 96 | 96 |

TABLE 2

| | Compar- | Compar- | Compar- | Compar- |
|---|---|---|---|---|
| | ative | ative | ative | ative |
| | Example | Example | Example | Example |
| | 1 | 2 | 3 | 4 |
| NR*1 | 35 | 35 | 35 | 35 |
| BR*2 | 65 | 65 | 65 | 65 |
| Polyamide elastomer *3 | — | — | — | — |
| Carbon black 1 *4 | 50 | 30 | — | — |
| Carbon black 2 *5 | — | — | 50 | 30 |
| Carbon black 3 *6 | — | — | — | — |
| Zinc oxide *7 | 3 | 3 | 3 | 3 |
| Stearic acid *8 | 1.5 | 1.5 | 1.5 | 1.5 |
| Anti-aging agent *9 | 3.25 | 3.25 | 3.25 | 3.25 |
| Wax *10 | 1 | 1 | 1 | 1 |
| Oil *11 | 12 | 12 | 12 | 12 |
| Sulfur *12 | 1.54 | 1.54 | 1.54 | 1.54 |
| Sulfur-containing | 0.8 | 0.8 | 0.8 | 0.8 |
| vulcanization | | | | |
| accelerator *13 | | | | |
| (C)/(B) | — | — | — | — |
| Test results | — | — | — | — |
| M100 | 100 | 100 | 100 | 100 |
| tanδ (60° C.) | 100 | 100 | 100 | 100 |
| | Compar- | Compar- | Compar- | Compar- |
| | ative | ative | ative | ative |
| | Example | Example | Example | Example |
| | 5 | 6 | 7 | 8 |
| NR*1 | 35 | 35 | 35 | 35 |
| BR*2 | 65 | 65 | 65 | 65 |
| Polyamide elastomer *3 | — | 20 | 30 | |
| Carbon black 1 *4 | — | — | — | — |
| Carbon black 2 *5 | — | — | — | — |
| Carbon black 3 *6 | 50 | 50 | 50 | 30 |
| Zinc oxide *7 | 3 | 3 | 3 | 3 |
| Stearic acid *8 | 1.5 | 1.5 | 1.5 | 1.5 |
| Anti-aging agent *9 | 3.25 | 3.25 | 3.25 | 3.25 |
| Wax *10 | 1 | 1 | 1 | 1 |
| Oil *11 | 12 | 12 | 12 | 12 |
| Sulfur *12 | 1.54 | 1.54 | 1.54 | 1.54 |
| Sulfur-containing | 0.8 | 0.8 | 0.8 | 0.8 |
| vulcanization | | | | |
| accelerator *13 | | | | |
| (C)/(B) | — | 0.4 | 0.6 | — |
| | | Against | Against | |
| | | Compar- | Compar- | |
| | | ative | ative | |
| | | Example | Example | |
| Test results | — | 5 | 5 | — |
| M100 | 100 | 142 | 156 | 100 |
| tanδ (60° C.) | 100 | 113 | 117 | 100 |
| | Compar- | Compar- | Compar- | Compar- |
| | ative | ative | ative | ative |
| | Example | Example | Example | Example |
| | 9 | 10 | 11 | 12 |
| NR*1 | 35 | 35 | 35 | 35 |
| BR*2 | 65 | 65 | 65 | 65 |
| Polyamide elastomer *3 | 15 | 30 | 10 | 10 |
| Carbon black 1 *4 | — | — | 50 | — |
| Carbon black 2 *5 | — | — | — | 50 |
| Carbon black 3 *6 | 30 | 30 | — | — |
| Zinc oxide *7 | 3 | 3 | 3 | 3 |
| Stearic acid *8 | 1.5 | 1.5 | 1.5 | 1.5 |
| Anti-aging agent *9 | 3.25 | 3.25 | 3.25 | 3.25 |
| Wax *10 | 1 | 1 | 1 | 1 |
| Oil *11 | 12 | 12 | 12 | 12 |
| Sulfur *12 | 1.54 | 1.54 | 1.54 | 1.54 |
| Sulfur-containing | 0.8 | 0.8 | 0.8 | 0.8 |
| vulcanization | | | | |
| accelerator *13 | | | | |
| (C)/(B) | 0.5 | 1 | 0.2 | 0.2 |
| | Against | Against | Against | Against |
| | Compar- | Compar- | Compar- | Compar- |
| | ative | ative | ative | ative |
| | Example | Example | Example | Example |
| Test results | 8 | 8 | 1 | 3 |
| M100 | 128 | 159 | 115 | 117 |
| Tanδ (60° C.) | 115 | 122 | 102 | 101 |

| | Compar- | Compar- | Compar- |
|---|---|---|---|
| | ative | ative | ative |
| | Example | Example | Example |
| | 13 | 14 | 15 |
| NR*1 | 35 | 35 | 35 |
| BR*2 | 65 | 65 | 65 |
| Polyamide elastomer *3 | 50 | 40 | 33 |
| Carbon black 1 *4 | 30 | — | 30 |
| Carbon black 2 *5 | — | 30 | — |
| Carbon black 3 *6 | — | — | — |
| Zinc oxide *7 | 3 | 3 | 3 |
| Stearic acid *8 | 1.5 | 1.5 | 1.5 |
| Anti-aging agent *9 | 3.25 | 3.25 | 3.25 |
| Wax *10 | 1 | 1 | 1 |
| Oil *11 | 12 | 12 | 12 |
| Sulfur *12 | 1.54 | 1.54 | 1.54 |
| Sulfur-containing | 0.8 | 0.8 | 0.8 |
| vulcanization | | | |
| accelerator *13 | | | |
| (C)/(B) | 1.6 | 1.3 | 1.1 |
| | Against | Against | Against |
| | Compar- | Compar- | Compar- |
| | ative | ative | ative |
| | Example | Example | Example |
| Test results | 2 | 4 | 1 |
| M100 | — | — | — |
| tanδ (60° C.) | — | — | — |

As is clear from Tables 1 and 2, the rubber compositions of Working Examples 1 to 8 contain (B) carbon black having a specific nitrogen adsorption specific surface area (N₂SA) and (C) a polyamide elastomer in specific amounts with respect to a diene rubber and at specific mass ratios of the (B) carbon black to the (C) polyamide elastomer, thereby yielding rubber compositions of superior rigidity and reduced heat build-up compared to the corresponding comparative examples. *1: NR (NUSIRA SIR20)*2: BR (Nipol BR1220, produced by Zeon Corporation)*3: Polyamide elastomer (UBESTAXPA P9040X1, manufactured by Ube Industries, Ltd.)*4: Carbon black 1 (Sho Black N339, manufactured by Cabot Japan Co., Ltd.; N₂SA=72 m²/g)*5: Carbon black 2 (Sho Black N550, manufactured by Cabot Japan Co., Ltd.; N₂SA=42 m²/g)*6: Carbon black 3 (HTC#G, manufactured by NSCC Carbon Co., Ltd.; N₂SA=27 m²/g)*7: Zinc oxide (Zinc Oxide #3, manufactured by Seido Chemical Industry Co., Ltd.)*8: Stearic acid (Stearic Acid, manufactured by NOF Corp.)*9: Anti-aging agent (Atigen 6C, manufactured by Sumitomo Chemical Co., Ltd.)*10: Wax (SANNOC, manufactured by Ouchi Shinko Chemical Industrial Co., Ltd.)*11: Oil (Extract No. 4S, manufactured by Showa Shell Sekiyu K.K.)*12: Sulfur (oil-treated sulfur, manufactured by Karuizawa Refinery Ltd.)*13: Sulfur-containing vulcanization accelerator (Sanceller CM-PO, manufactured by Sanshin Chemical Industry Co., Ltd.)

By contrast, the rubber compositions of Comparative Examples 2 to 5 and 8 contain no (C) polyamide elastomer, and therefore exhibit no improvement in heat build-up despite containing various types of carbon black.

In Comparative Examples 6, 7, 9, and 10, the nitrogen specific surface area (N₂SA) of the (B) carbon black is less than the minimum stipulated by the present technology, resulting in worse heat build-up.

In Comparative Examples 11 and 12, the mass ratio of the (B) carbon black to the (C) polyamide elastomer is less than the minimum stipulated by the present technology, resulting in worse heat build-up.

In Comparative Examples 13, 14, and 15, the mass ratio of the (B) carbon black to the (C) polyamide elastomer exceeds the maximum stipulated by the present technology, resulting in reduced workability.

(i) A comparison of Comparative Example 1, Working Example 1, Working Example 2, and Comparative Example 11, in which the amount of the (C) polyamide elastomer was varied while leaving the amounts of the other feedstock materials the same, shows that only Working Examples 1 and 2, in which the mass ratio of the (B) carbon black to the (C) polyamide elastomer are within the range stipulated by the present technology, exhibited superior rigidity and heat build-up properties.

(ii) A comparison of Comparative Example 2, Working Example 3, Working Example 4, and Comparative Example 13, in which the amount of the (C) polyamide elastomer was varied while leaving the amounts of the other feedstock materials the same, and the amount of added carbon black differed from (i), shows that only Working Examples 3 and 4, in which the mass ratio of the (B) carbon black to the (C) polyamide elastomer are within the range stipulated by the present technology, exhibited superior rigidity and heat build-up properties.

(iii) A comparison of Comparative Example 3, Working Example 5, Working Example 6, and Comparative Example 12, in which the amount of the (C) polyamide elastomer was varied while leaving the amounts of the other feedstock materials the same, and the nitrogen adsorption specific surface area (N₂SA) of the carbon black differed from (i), shows that only Working Examples 5 and 6, in which the mass ratio of the (B) carbon black to the (C) polyamide elastomer are within the range stipulated by the present technology, exhibited superior rigidity and heat build-up properties.

(iv) A comparison of Comparative Example 4, Working Example 7, Working Example 8, and Comparative Example 14, in which the amount of the (C) polyamide elastomer was varied while leaving the amounts of the other feedstock materials the same, and the amount of added carbon black differed from (iii), shows that only Working Examples 7 and 8, in which the mass ratio of the (B) carbon black to the (C) polyamide elastomer are within the range stipulated by the present technology, exhibited superior rigidity and heat build-up properties.

1. A rubber composition comprising, 100 parts by mass of (A) a diene rubber containing from 20 to 50 parts by mass of a natural rubber and from 50 to 80 parts by mass of a butadiene rubber, from 30 to 80 parts by mass of (B) carbon black having a nitrogen adsorption specific surface area (N₂SA) of from 35 m²/g to 45 m²/g and from 1 to 30 parts by mass of (C) a polyamide elastomer, a mass ratio of the (B) carbon black to the (C) polyamide elastomer being 1:0.4 to 1:1.

2. The rubber composition according to claim 1, wherein the mass ratio of the (B) carbon black to the (C) polyamide elastomer is 1:0.4 to 1:0.8.

3. The rubber composition according to claim 1, wherein the mass ratio of the (B) carbon black to the (C) polyamide elastomer is 1:0.4 to 1:0.6.

4. (canceled)

5. The rubber composition according to claim 1, wherein the (C) polyamide elastomer has a soft segment Shore D hardness value at least 10 less than a hard segment Shore D hardness value thereof.

6. The rubber composition according to claim 5, wherein a difference between the soft segment Shore D hardness and the hard segment Shore D hardness of the (C) polyamide elastomer is 30 to 50.

7. A tire sidewall rubber composition comprising the rubber composition described in claim 1.

8. A tire bead filler rubber composition comprising the rubber composition described in claim 1.

9. A pneumatic tire wherein the rubber composition described in claim 7 is used in a sidewall thereof.

10. A pneumatic tire wherein the rubber composition described in claim 8 is used in a bead filler thereof.
